(19) United States
(12) Patent Application Publication
(10) Pub. No.: US 2011/0149734 A1
(43) Pub. Date: Jun. 23, 2011

(54) SMART BORDER ROUTER AND METHOD FOR TRANSMITTING FLOW USING THE SAME

(75) Inventors: Hea Sook PARK, Daejeon (KR); Ki Cheol Jeon, Daejeon (KR); Boo Geum Jung, Daejeon (KR); Byungjun Ahn, Daejeon (KR)

(73) Assignee: Electronics and Telecommunications Research Institute, Daejeon (KR)

(21) Appl. No.: 12/911,961

(22) Filed: Oct. 26, 2010

(30) Foreign Application Priority Data
Dec. 21, 2009 (KR) 10-2009-0128423

(51) Int. Cl. H04L 12/26

(52) U.S. Cl. 370/235

(57) ABSTRACT

A smart border router includes a traffic analyzer for receiving a traffic control policy including a network's routing policy and QoS policy from a router provided on a border of a network, and analyzing the same; a flow translator for, when receiving a plurality of flows from a specific network, translating a received flow to satisfy the traffic control policy of a destination network to which the flow will be transmitted; and a flow information controller for transmitting the translated flow to the destination network through a flow control protocol.

### CROSS-REFERENCE TO RELATED APPLICATION

This application claims priority to and the benefit of Korean Patent Application No. 10-2009-0128423 filed in the Korean Intellectual Property Office on Dec. 21, 2009, the entire contents of which are incorporated herein by reference.

### BACKGROUND OF THE INVENTION

(a) Field of the Invention

The present invention relates to a method for a router to transmit packets, and more particularly, to a smart boarder router and a method for transmitting flow using the same.

(b) Description of the Related Art

Methods for efficiently using addresses and methods for translating addresses or ports have been proposed for the Internet because of insufficiency of IP addresses and misuse of protocol ports.

However, the conventional routers cannot provide application-based routing, security, and quality of service (QoS), and are only available for application-level packet classification.

A border router positioned on the border of the network has no method for applying or transmitting recognized information to multi-hops of the network or terminal-to-terminal, and it requires expansion of the routing protocol in order to apply routing, QoS, and security policy to the network.

The above information disclosed in this Background section is only for enhancement of understanding of the background of the invention and therefore it may contain information that does not form the prior art that is already known in this country to a person of ordinary skill in the art.

### SUMMARY OF THE INVENTION

The present invention has been made in an effort to provide a smart border router for controlling traffic at a border router by using flow information, and a method for transmitting flow information.

An exemplary embodiment of the present invention provides a method for a router to transmit flow information including: receiving a traffic control policy including network routing policy and QoS policy from a network on which the router is provided or a neighboring network, and analyzing the traffic control policy; when receiving a plurality of flows from a specific network, translating a received flow so as to fit the traffic control policy of a destination network to which the flow will be transmitted; and transmitting the translated flow to the destination network through a flow control protocol.

Another embodiment of the present invention provides a smart border router including a traffic analyzer for receiving a traffic control policy including: a network's routing policy and QoS policy from a router provided on a border of a network and analyzing the same; a flow translator for, when receiving a plurality of flows from a specific network, translating a received flow to satisfy the traffic control policy of a destination network to which the flow will be transmitted; and a flow information controller for transmitting the translated flow to the destination network through a flow control protocol.

### BRIEF DESCRIPTION OF THE DRAWINGS

FIG. 1 shows a network schematic diagram for applying a smart border router (SBR) according to an exemplary embodiment of the present invention.

FIG. 2 shows a block diagram of an internal configuration of a smart border router (SBR) according to an exemplary embodiment of the present invention.

FIG. 3 shows a schematic view for indicating a flow aggregation function and a flow translation function performed by a smart border router (SBR) according to an exemplary embodiment of the present invention.

FIG. 4 shows parameters of a flow control protocol according to an exemplary embodiment of the present invention.

FIG. 5 shows a method for a smart border router (SBR) to transmit flow information according to an exemplary embodiment of the present invention.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

Throughout the specification, unless explicitly described to the contrary, the word “comprise” and variations such as “comprises” or “comprising” will be understood to imply the inclusion of stated elements but not the exclusion of any other elements.

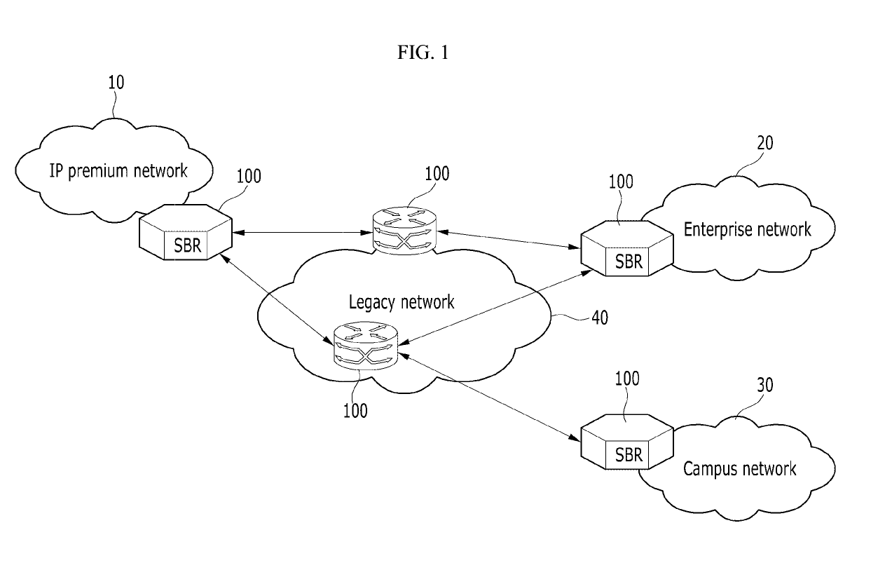

FIG. 1 shows a network schematic diagram for applying a smart border router (SBR) according to an exemplary embodiment of the present invention.

The SBR 100 recognizes dynamic flow, application for indicating service types, and a routing policy at the input end of a private network and an access network and translates them into flow information suitable for currently supported traffic control and routing policy.

The SBR 100 transmits flow information to the network through a flow control protocol in the multi-hop or terminal-to-terminal manner.

The SBR 100 is provided in the border area of the network when connected from an IP premium network 10, an enterprise network 20, and a campus network 30 to a legacy network 40.

The SBR 100 aggregates and translates the flow and maps the flow to satisfy the traffic control policy of legacy equipment. Here, the flow means an identifier for classifying similar users of a session, a tunnel, and a circuit, or service-based packets, and applying the same forwarding or QoS policy to packets with the same flow. In this instance, the flow aggregation is a set of a plurality of flows having the same or similar characteristics. Also, the flow aggregation simplifies flow classification in the network application and processes a large number of packets.

The flow translation of the SBR 100 provides cooperation of the QoS policy of the IP premium network 10, cooperation with existing equipment through extension problem solutions and efficient traffic control, and provides topology hiding of the enterprise network 20, the campus network 30, and the private network protection function to enable building of the private network.

The SBR 100 transmits the flow aggregation to the network through the flow control protocol according to an access control list (ACL), DiffServ code point (DSCP), and traffic control policy.

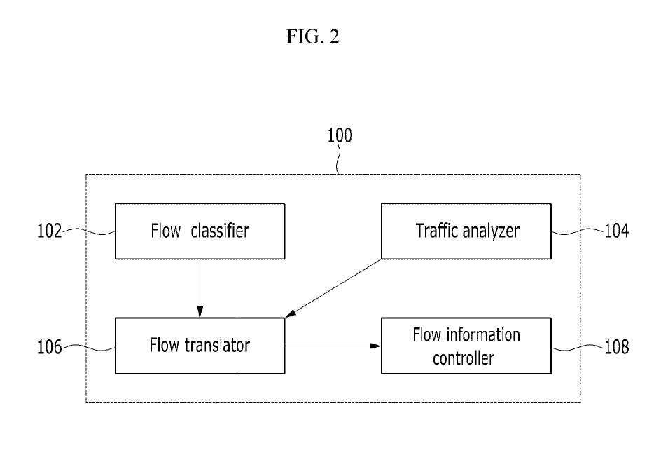

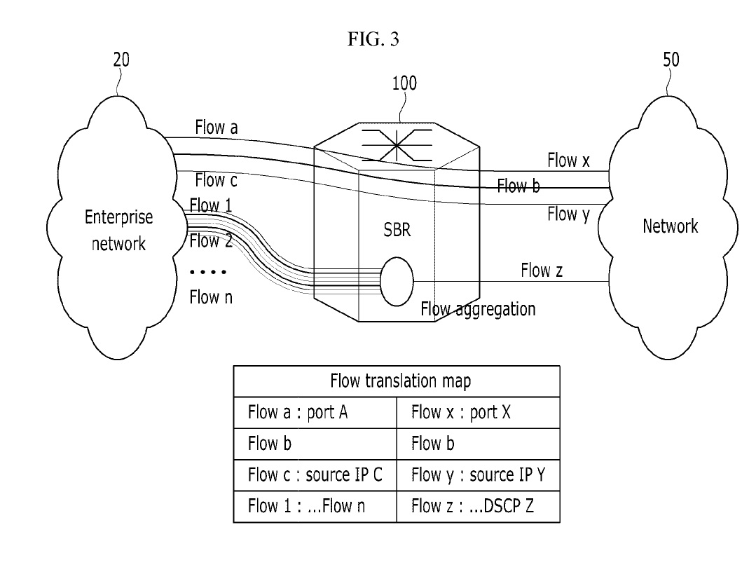

FIG. 2 shows a block diagram of an internal configuration of a smart border router (SBR) according to an exemplary embodiment of the present invention, and FIG. 3 shows a schematic view for indicating a flow aggregation function and a flow translation function performed by a smart border router (SBR) according to an exemplary embodiment of the present invention.

The SBR 100 includes a flow classifier 102, traffic analyzer 104, a flow translator 106, and a flow information controller 108.

The flow classifier 102 is a flow-based router and can identify several million flows, and as shown in FIG. 3, it receives a plurality of packets from the enterprise network 20 or a network 50 and identifies the packets by sorting the packets for respective IP addresses. The IP network identifies the packets by sorting packets of a 6-tuple. In this instance, the 6-tuple includes a source IP, a destination IP, a source port, a destination port, a protocol type, and a DSCP.

The traffic analyzer 104 receives a plurality of flows, applications including service categories or types, routing policy, QoS policy, and security policy through the network on which the SBR 100 is provided, the neighboring network, or an external server, and analyzes the traffic control policy of the neighboring network and the network on which the SBR 100 is provided. For example, the traffic analyzer 104 analyzes the traffic control policy including applications for packet transmission, routing policy, QoS policy, and security policy such as by what bandwidth the packets will be transmitted from a specific network or with what priority they will be transmitted.

The flow translator 106 translates the received flow to satisfy the traffic control policy of the network for transmitting the network.

For example, as shown in FIG. 3, the flow A has a port A and it is translated into the flow X with a port X, and in detail, a voice over Internet protocol (VoIP) packet must be transmitted to a specific port X, and the port to number A of the packet having violated this is translated into X.

The flow B is transmitted with translation.

The flow C with the source IP C is changed into the flow Y with the source IP Y. The IP address C of the inner network is used in the enterprise network 20, and it is changed into the source IP Y, which is the representative address, in the network 50.

The flows 1 through n are a set of flows Z for setting the DSCP value as the flow Z, and the DSCP values are set in the descending order of priorities for all VoIP packets.

The flow information controller 108 transmits the translated flow or flow aggregation to the destination network through a flow control protocol.

The flow information controller 108 defends the network and provides network-based QoS by transmitting service denial attack and fire wall filtering information to the network through the flow control protocol.

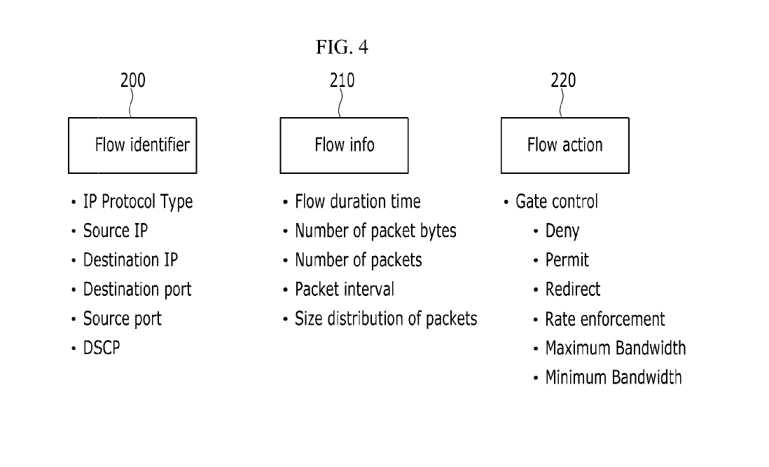

Parameters of the flow control protocol will now be described in detail with reference to FIG. 4.

FIG. 4 shows parameters of a flow control protocol according to an exemplary embodiment of the present invention.

The flow control protocol can be realized through an additional network control server or can be controlled by an IP multimedia sub-system, and the parameters of the flow control protocol can be transmitted by extending the routing protocol of the network.

When the flow control protocol is applied by extending the routing protocol of the network, it is applicable through a software patch or upgrade of to the SBR 100.

A flow identifier 200 shows the 6-tuple that is information used to identify the flow.

The flow information 210 includes a flow duration time, a number of transmitted packet bytes, a number of packets, a packet transmission interval, and a size distribution of packets for analyzing and monitoring actions of the flow. Here, the size distribution of packets is flow information for detecting an action of the flow that transmits many small packet or big packets.

The flow action 220 includes gate control and rate enforcement.

The gate control sets acts including blocking, allowing, and path resetting so as to set a right for the flow to access the network.

The rate enforcement can set threshold values of the maximum and minimum bandwidths.

The flow information controller 108 controls traffic of the translated flow or flow aggregation by controlling the parameter of the flow control protocol.

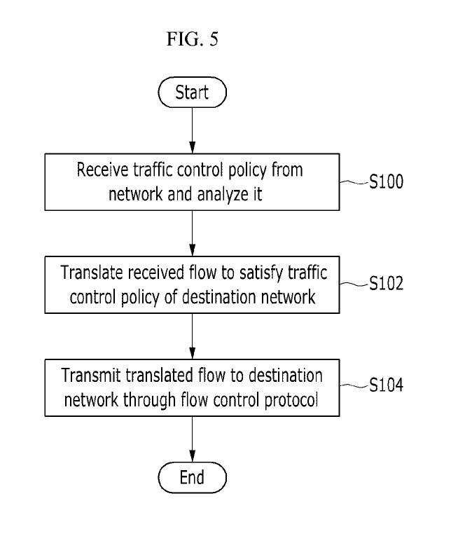

FIG. 5 shows a method for a smart border router (SBR) to transmit flow information according to an exemplary embodiment of the present invention.

The traffic analyzer 104 receives the traffic control policy including the network's routing policy, QoS policy, and security policy from the network on which the SBR 100 is provided or the neighboring network, and analyzes the same (S100).

In the case of receiving a plurality of flows, the flow translator 106 translates the flow that is received to satisfy the traffic control policy of the destination network to which the flow will be transmitted (S102). In detail, the flow translator 106 translates the received flows to satisfy the traffic control policy through the flow aggregation function and the IP header's translation function.

The flow information controller 108 transmits the flow translated by the flow translator 106 to the destination network through the flow control protocol (S104). Also, the flow information controller 108 controls the parameter of the flow control protocol and transmits the flow translated by the flow translator 106 to control the traffic.

According to an embodiment of the present invention, a routing/traffic control function depending on network protection and conditions is provided.

Also, it is possible to efficiently defend the network and provide network-based QoS by quickly transmitting service denial attack and fire wall filtering information through a flow control protocol.

In addition, it is possible to increase the efficiency of the network resource through flow aggregation and a translation function.

The above-described embodiments can be realized through a program for realizing functions corresponding to the configuration of the embodiments or a recording medium for recording the program in addition to through the above-described device and/or method, which is easily realized by a person skilled in the art.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A method for a router to transmit flow information, comprising:
receiving a traffic control policy including network routing policy and quality of service (QoS) policy from a network on which the router is provided or a neighboring network and analyzing the traffic control policy;
when receiving a plurality of flows from a specific network, translating a received flow so as to fit traffic control policy of a destination network to which the flow will be transmitted; and
to transmitting the translated flow to the destination network through a flow control protocol.

2. The method of claim 1, wherein
the translating of the received flow includes
translating the received flow to satisfy the traffic control policy through a flow aggregation function and an IP header's translation function.

3. The method of claim 1, wherein
the transmitting to the destination network includes
controlling traffic by controlling a flow identifier for identifying a flow that is a parameter of the flow protocol, flow information for analyzing and monitoring actions of the flow, and a flow action for setting the flow's network access right and a bandwidth rate.

4. A smart border router for transmitting flow information comprising:
a traffic analyzer for receiving a traffic control policy including a network's routing policy and QoS policy from a router provided on a border of a network and analyzing the same;
a flow translator for, when receiving a plurality of flows from a specific network, translating a received flow to satisfy the traffic control policy of a destination network to which the flow will be transmitted; and
a flow information controller for transmitting the translated flow to the destination network through a flow control protocol.

5. The smart border router of claim 4, wherein
the flow information controller controls traffic by controlling a flow identifier of a flow that is a parameter of the flow protocol, flow information for analyzing and monitoring actions of the flow, and a flow action for setting the flow's network access right and a bandwidth rate from the flow control protocol.

6. The smart border router of claim 4, wherein
the flow translator translates the received flows to satisfy the traffic control policy through a flow aggregation function and an IP header's translation function.

7. The smart border router of claim 4, wherein
the flow control protocol is applied by extending a routing protocol of the network.
